(19) United States
(12) Patent Application Publication
(10) Pub. No.: US 2004/0203461 A1
(43) Pub. Date: Oct. 14, 2004

(54) Method and system for providing GPS interference information from a civilian mobile vehicle communications system

(75) Inventor: Curtis L. Hay, Clarkston, MI (US)

Correspondence Address: General Motors Corporation, Legal Staff, Mail Code 482-C23-B21, 300 Renaissance Center, P. O. Box 300, Detroit, MI, 48265-3000, US

(73) Assignee: General Motors Corporation

(21) Appl. No.: 10/293,771

(22) Filed: Nov. 13, 2002

(51) Int. Cl. H04Q 7/20; H04B 17/00

(52) U.S. Cl. 455/67.13; 455/67.11; 455/456.1

(57) ABSTRACT

A method is directed to providing global positioning system interference information from a civilian mobile vehicle communication service. The method provides for requesting interference information corresponding to a specified profile from at least one mobile vehicle within a mobile vehicle communication service, monitoring the mobile vehicle communication service, receiving the requested interference information from the at least one mobile vehicle within the mobile vehicle communication service, determining at least one interference region based on the received interference information, and transmitting the at least one determined interference region to a client. The step of determining at least one interference region may further include storing the interference information within a database, mapping the interference information to an associated geographic representation, and identifying at least one interference region based on the mapped interference information.

### FIELD OF THE INVENTION

In general, the invention relates to Global Positioning System (GPS) transmissions as well as data transmission over a wireless communication system. More specifically, the invention relates to a method and system for providing GPS interference information from a mobile vehicle communication system.

### BACKGROUND OF THE INVENTION

Mobile communication units (MCU's), such as cellular phones, personal data assistants (PDA's), and on-board Vehicle Communication Units (VCU's), used in conjunction with a Wide Area Network (WAN), such as a cellular telephone network or a satellite communication system, have made it possible for a person to send and receive voice communications, data transmissions, and FAX messages from virtually anywhere on earth. Such communication is initiated at the MCU when it is turned on, or by entering a phone number to be called, or in many cases, by pressing a preprogrammed button on the MCU or speaking a voice command causing the MCU to automatically complete the process of dialing the number to be called. A radio communication link is established between the MCU and a Wide Area Network (WAN), using a node of the WAN in the vicinity of the MCU.

In cellular telephone systems, a node is commonly referred to as a “cellular base station.” Once the radio communication link between the MCU and the cellular base station has been established, the base station then utilizes a combination of additional cellular stations, conventional telephone wire line networks, and possibly even satellite systems to connect the MCU to the number to be called.

Wireless communication services for MCU users, such as navigation and roadside assistance that utilize GPS, have increased rapidly in recent years. Most of the services that have been offered are for a motor vehicle in operation, and include services that may require location and destination information, usually provided utilizing GPS data. MCU service providers must make available a wireless communication service customer assistance center (or other such manually staffed service center) in order that an operator or customer assistant may complete the MCU requests.

International use of GPS has far exceeded the expectations of its original planners and system architects. Originally envisioned as a military system for precise navigation and timing, it has become a central feature and key component of the global economy. GPS satellite receivers are used for a tremendous number of important applications including cellular communications, power grid distribution and timing, internet services, electronic banking and stock trading, commercial and private navigation, and military operations. The use of GPS within the scientific, industrial, military, and educational domains will continue to increase for many years to come.

Despite its widespread and pervasive use throughout the global economy, it is a well-known fact that GPS receivers are highly vulnerable to electromagnetic interference. Even very low levels of stray energy within the GPS spectrum will completely prevent receivers from functioning. Interfering radio frequency (RF) energy may come from cellular transmission equipment, wireless devices, power generation equipment, and even household appliances. Intentional jamming will also disrupt GPS, although this criminal activity is far less likely to disrupt receivers than unintentional jamming.

Recently, additional services have been developed that may be beneficial to both the MCU user as well as the MCU service provider. One such service beneficial to the MCU user includes the ability of the MCU service provider to query onboard systems and components to determine how well each system is performing. Results from the query may provide the MCU service provider the ability to notify the MCU user of potential problems with the system and schedule a repair session, if necessary.

Services beneficial to the MCU service provider include the ability to query additional onboard systems, such as MCU GPS device performance. Unfortunately, the present process only identifies MCU hardware/software irregularities and defects. Many GPS performance issues result from GPS signal interference between a GPS source and a GPS receiver, as described above.

It would be desirable, therefore, to provide a method and system that would overcome these and other disadvantages.

### SUMMARY OF THE INVENTION

The present invention is directed to a system and method for providing Global Positioning System (GPS) interference information from a mobile vehicle communication system (MVCS). The invention allows a service provider to request GPS interference information, generate one or more interference regions, and provide requested interference information to a client.

One aspect of the invention provides a method for obtaining global positioning system (GPS) interference information from a mobile vehicle communication service by requesting interference information corresponding to a specified profile from at least one mobile vehicle within a mobile vehicle communication service, monitoring the mobile vehicle communication service, receiving the requested interference information from the at least one mobile vehicle within the mobile vehicle communication service, determining at least one interference region based on the received interference information, and transmitting the at least one determined interference region to a client.

In accordance with another aspect of the invention, a system for obtaining Global Positioning System (GPS) interference information from a mobile vehicle communication service is provided. The system includes means for requesting interference information corresponding to a specified profile from at least one mobile vehicle within a mobile vehicle communication service. The system further includes means for monitoring the mobile vehicle communication service. Means for receiving the requested interference information from the at least one mobile vehicle within the mobile vehicle communication service is provided. Means for determining at least one interference region based on the received interference information and means for transmitting at least one determined interference region to a client is also provided.

In accordance with yet another aspect of the invention, a computer readable medium storing a computer program includes: computer readable code for requesting interference information corresponding to a specified profile from at least one mobile vehicle within a mobile vehicle communication service, computer readable code for monitoring the mobile vehicle communication service, computer readable code for receiving the requested interference information from the at least one mobile vehicle within the mobile vehicle communication service, computer readable code for determining at least one interference based on the received interference information, and computer readable code for transmitting the at least one determined interference to a client.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating an operating environment according to an embodiment of the present invention;

FIG. 2 is a block diagram illustrating an operating GPS receiver according to an embodiment of the present invention; and

FIG. 3 is a flow diagram depicting an exemplary embodiment of code on a computer readable medium in accordance with the present invention.

### DETAILED DESCRIPTION OF THE PRESENTLY PREFERRED EMBODIMENT

Throughout the specification, and in the claims, the term “connected” means a direct electrical connection between the things that are connected, without any intermediate devices. The term “coupled” means either a direct electrical connection between the things that are connected, or an indirect connection through one or more passive or active intermediary devices.

The present invention relates to GPS transmissions and more particularly to providing GPS interference information from a mobile vehicle communication system. The present invention allows a service provider to request and receive GPS interference information over a mobile communication system, determine one or more interference, and transmit the determined information to a client.

Illustrative Operating Environment

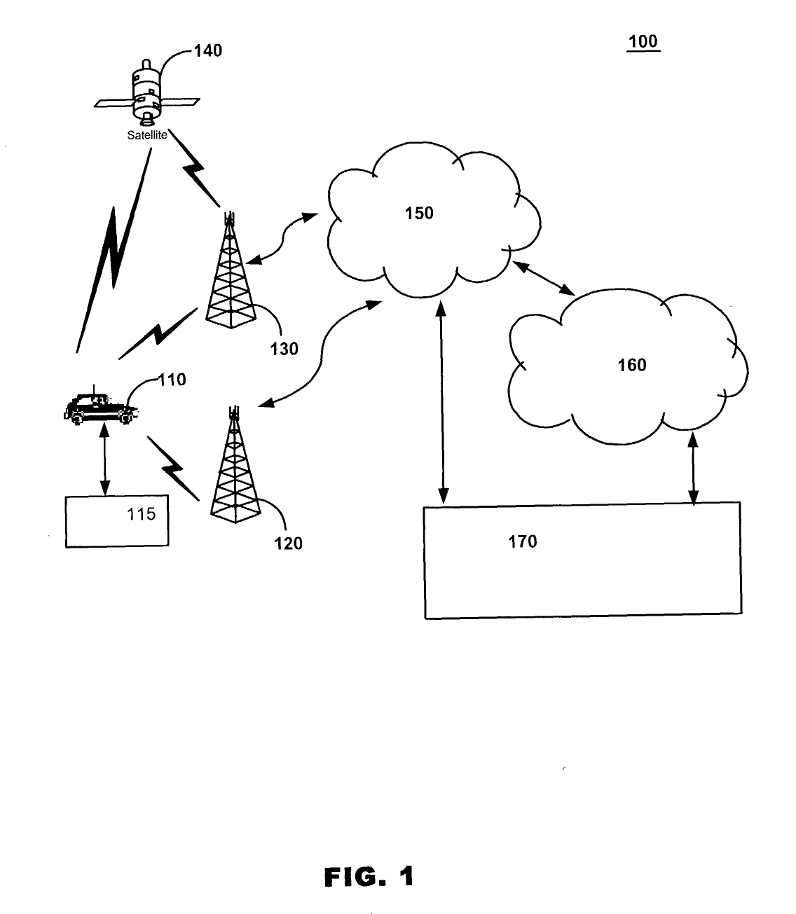

FIG. 1 is a block diagram illustrating an example of an operating environment that is in accordance with the present invention. FIG. 1 details an embodiment of a system for operating a global positioning service and a wireless communication service in a mobile vehicle, in accordance with the present invention, and may be referred to as a mobile vehicle communication system (MVCS) 100. The mobile vehicle communication system (MVCS) 100 may include one or more mobile vehicle communication units (MVCU) 110, one or more MVCS devices 115, one or more wireless communication systems 120, one or more GPS radio carrier systems 130, one or more GPS satellite broadcast systems 140, one or more communication networks 150, one or more land networks 160, and one or more service providers 170.

In one example, MVCS 100 is implemented as an OnStar system, as is known in the art, with regards to wireless communications, and as a GPS system, as is known in the art, with regards to satellite and radio GPS communications.

MCVU 110 includes a wireless vehicle communication device (module, MVCS module) such as an analog or digital phone with suitable hardware and software for transmitting and receiving data communications. In one embodiment, MCVU 110 further includes a wireless modem for transmitting and receiving data. In another embodiment, MCVU 110 includes a digital signal processor with software and additional hardware to enable communications with the mobile vehicle and to perform other routine and requested services.

Additionally, MCVU 110 includes a global positioning system (GPS) unit capable of determining synchronized time and a geophysical location of the mobile vehicle. In operation, MCVU 110 sends to and receives radio transmissions from wireless communication system 120. MCVU 110 may also be referred to as a mobile vehicle throughout the discussion below. In operation, MCVU 110 may be implemented as a motor vehicle, a marine vehicle, or as an aircraft.

MVCS device 115 includes hardware suitable for receiving broadcast signals within MCVU 110. In one embodiment, MVCS device 115 includes a receiver and receives broadcasts from wireless communication system 120, GPS radio broadcast system 130, and GPS satellite broadcast system 140.

In another embodiment, MVCS device 115 further includes a medium for storing programming information. In an example, the programming information includes provider supplied programs. Supplied programs may include such programs as GPS reception, navigation, diagnostic, and the like.

In yet another embodiment, MVCS device 115 further includes an audio speaker, a synthesized voice output, an audio channel, or the like. In an example, MVCS device 115 is implemented, in addition to the receiver, as a set of headphones, the audio portion of a television, a display device, or the like.

In another embodiment, MCVU 110 includes a speech recognition system (ASR) module capable of communicating with MVCS device 115. In yet another embodiment, the module is capable of functioning as any part or all of the above communication devices and, for another embodiment of the invention, may be capable of data storage, and/or data retrieval, and/or receiving, processing, and transmitting data queries. In one example, MVCS device 115 includes a speech recognition system (ASR) module.

Wireless communications system 120 is a wireless communications carrier or a mobile telephone system and transmits to and receives signals from one or more MCVU 110. Wireless communication system 120 incorporates any type of telecommunications in which electromagnetic waves carry signal over part of or the entire communication path. In one embodiment, wireless communication system 120 is implemented as any type of broadcast communication in addition to those of GPS radio broadcast system 130 and GPS satellite broadcast system 140. In another embodiment, wireless communications system 120 is implemented as a single unit in conjunction with GPS radio broadcast system 130. In another embodiment, wireless communications system 120 is implemented via coupling with GPS radio broadcast system 130, or in some such other configuration as would allow the systems to function as described.

In one example, such wireless communication carrier is a short message service, modeled after established protocols such as IS-637 SMS standards, IS-136 air interface standards for SMS, and GSM 03.40 and 09.02 standards. Similar to paging, an SMS communication could be broadcast to a number of regional recipients.

In another example, the mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications.

GPS radio broadcast system 130 transmits radio signals with data to MVCS device 115 within MCVU 110. In one embodiment, GPS radio broadcast system 130 transmits analog audio and/or video signals. In an example, GPS radio broadcast system 130 transmits analog audio and/or video signals such as those sent from AM and FM radio stations and transmitters, or digital audio signals in the S band (approved for use in the U.S.) and L band (used in Europe and Canada).

In another embodiment, MVCS device 115 stores or retrieves data and information from the audio and/or video signals of GPS radio broadcast system 130. In an example, MVCS device 115 retrieves terrestrial digital GPS radio signals from a signal received from GPS radio broadcast system 130.

GPS satellite broadcast system 140 transmits radio signals to MVCS device 115 within MCVU 110. In one embodiment, GPS satellite broadcast system 140 may broadcast over a spectrum in the “L” band (1.5 GHz) that has been allocated by the U.S. Federal Communications Commission (FCC) for nationwide broadcasting of GPS satellite-based services. In an example, GPS satellite broadcast system 140 may be implemented as a global positioning service (GPS). In another embodiment, GPS satellite broadcast system 140 may broadcast over a foreign global positioning system, such as, for example, the Russian Global Navigation Satellite System (GLONASS).

In operation, broadcast services provided by GPS radio broadcast system 130 and GPS satellite broadcast system 140 are received by MVCS device 115 located within MCVU 110.

Communications network 150 is implemented as any suitable system or collection of systems for connecting wireless communications system 120 to at least one MCVU 110 or to a service provider 170. In one embodiment, communications network 150 includes a mobile switching center and provides services from one or more wireless communications companies.

Land network 160 connects communications network 150 to service provider 170. In one embodiment, land network 160 is implemented as a public-switched telephone network, a wired network, an optical network, a fiber network, another wireless network, or any combination thereof. In an example, land network 160 includes an Internet protocol (IP) network. In another embodiment, an MCVU 160 utilizes all or part of the wireless communications system 120, communications network 150, and land network 160.

In yet another embodiment, land network 160 connects one or more communications systems 120 to one another. In another embodiment, communication network 150 and land network 160 connect wireless communications system 120 to a communication node or service provider 170.

Service provider 170 is implemented as one or more locations where communications may be received or originate to facilitate functioning of the mobile vehicle communication system (MCVS) 100. Service provider 170 may contain any of the previously described functions.

In one embodiment, service provider 170 is implemented as a call center, as known in the art. In an example, the call center is implemented as a voice call center, providing verbal communications between an advisor in the call center and a subscriber in a mobile vehicle. In another example, the call center is implemented as a voice activated call center, providing verbal communications between an ASR unit and a subscriber in a mobile vehicle. In yet another example, the call center is implemented as a virtual call center, providing virtual communications between a virtual advisor and a user interface. In another embodiment, the call center contains any of the previously described functions.

In an example, the call center is implemented to service an OnStar system. In another example, the call center is implemented to service a GPS satellite system. In yet another example, the call center is implemented to service one or more of the above examples, or other services.

In operation, a service provider 170 utilizes one or more portions of the aforementioned communications network to communicate GPS data and service provider programming to MVCS device 115. The provider programming may then be utilized by MVCS device 115 in addition to one or more GPS radio broadcast system 130 and GPS satellite broadcast system 140 segments to implement the present invention.

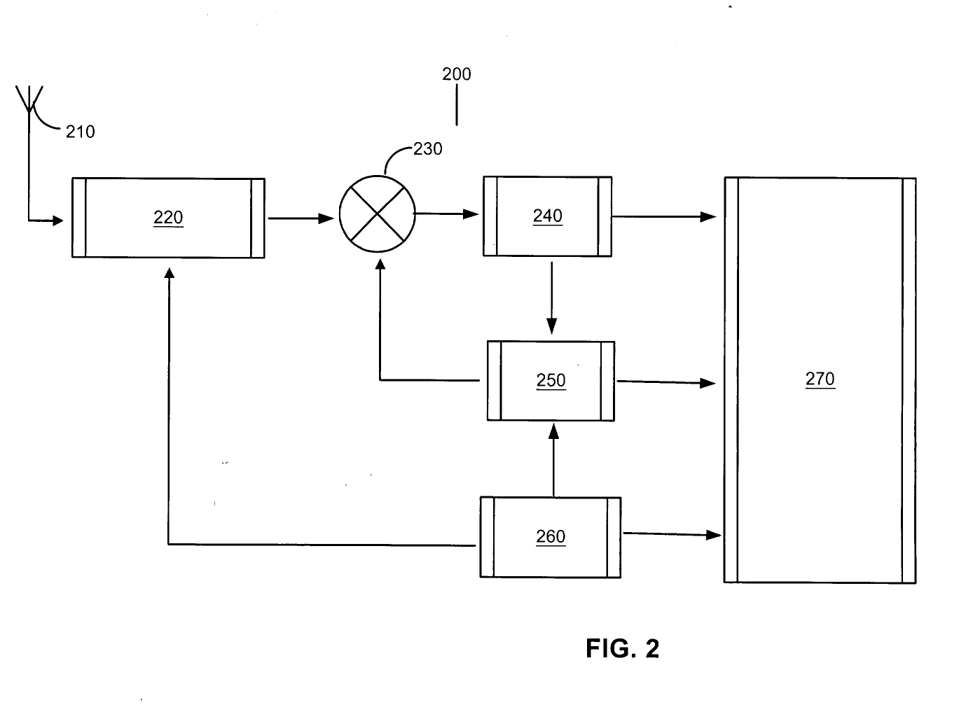

FIG. 2 is a block diagram illustrating an operating global positioning service (GPS) receiver in accordance with the present invention. FIG. 2 details components utilized in receiving, decoding, and implementing a GPS signal according to one embodiment of the present invention.

In FIG. 2 GPS receiver 200 includes antenna 210, preamplifier 220, mixer 230, demodulator 240, access code generator 250, clock 260, and receiver processing unit 270. In one embodiment, GPS receiver 200 is implemented as part of MCVS device described in FIG. 1 above.

In FIG. 2, antenna 210 is coupled to preamplifier 220. Preamplifier 220 is further coupled to mixer 230 and clock 260. Mixer 230 is further coupled to demodulator 240 and access code generator 250. Demodulator 240 is further coupled to access code generator 250 and receiver processing unit 270. Access code generator 250 is further coupled to clock 260 and receiver processing unit 270. Clock 260 is further coupled to receiver processing unit 270.

Antenna 210 is a GPS signal reception device suitable for receiving a GPS signal, as known in the art. In one embodiment, the antenna 210 utilized is designed to receive a 1.5 GHz signal. Preamplifier 220 is a hardware component that receives the GPS signal from antenna 210 and a clock signal from clock 260. Preamplifier 220 amplifies and converts the received GPS signal to a frequency and magnitude suitable for sampling. Preamplifier 220 may be implemented as any suitable preamplifier/converter component, as known in the art.

Mixer 230 is a hardware component that receives the amplified/converted signal from preamplifier 220 and a civilian access code measurement from access code generator 250. Mixer 230 provides a reference frequency utilized by GPS receiver 200 to correlate the transmitted signal. In one embodiment, mixer 230 provides a Doppler Frequency Measurement (DFM). Mixer 230 may be implemented as any suitable mixing component, as known in the art.

Demodulator 240 is a hardware component that receives the reference signal produced by mixer 230 and produces a navigation message and a code control message. Demodulator 240 transmits the navigation message to receiver processing unit 270 and further transmits the code control message to access code generator 250. Demodulator 240 may be implemented as any suitable demodulating component, as known in the art.

Access code generator 250 is a hardware component that receives the code control message from demodulator 240 and a clock signal from clock 260. Access code generator 250 generates the civilian access code measurement allowing synchronization and decoding of the received GPS signal. Access code generator 250 transmits the civilian access code measurement to mixer 230 and receiver processing unit 270. In one embodiment, access code generator 250 is implemented as a type of shift register. In one example, access code generator 250 is implemented as a linear feedback shift register (LFSR).

Clock 260 is a hardware component that produces a clock measurement, also referred to as the clock signal, utilized for synchronous timing of GPS receiver 200. Clock 260 transmits the clock signal to preamplifier 220, access code generator 250, and receiver processing unit 270. In one embodiment, clock 260 is implemented as a reference oscillator providing a timing standard with which to synchronize access code generator 250.

Receiver processing unit 270 is a hardware component capable of receiving data, analyzing the received data to determine positional location, and determining the validity of the analyzed data. Receiver processing unit 270 receives the navigation message from demodulator 240, the access code measurement from access code generator 250, and the clock measurement from clock 260. Receiver processing unit 270 produces location information such as position, velocity, and the like, based on the received data.

In one embodiment, receiver processing unit 270 determines data bit alignment, data parity, and data decoding based on data received from demodulator 240. In another embodiment, receiver processing unit 270 performs other determinations, such as, for example, satellite positions which may include raw measurement data, pseudo range correction which may include a satellite identifier utilized in conjunction with a lookup table/almanac, pseudo range, receiver position, velocity, and time computations based on data received from demodulator 240, access code generator 250, and clock 260.

In yet another embodiment, receiver processing unit 270 produces a combination of the above described determinations based on defined program parameters. In one embodiment, such defined program parameters are determined by a manufacturer based on a service provider's determined needs.

Receiver processing unit 270 is additionally designed to store invalid data matching specified parameters, for transmitting to service provider 170 upon request. In one embodiment, receiver processing unit 270 is implemented as part of a central processing unit. In another embodiment, receiver processing unit 270 is implemented as a separate processing unit.

In FIG. 2, each component represents a function performed by GPS receiver 200 and includes an associated output that is monitored and utilized in determining if a received GPS signal is subject to interference, also referred to as jamming. In one embodiment, associated component outputs from mixer 230, demodulator 240, access code generator 250, clock 260, and receiver processing unit 270 are analyzed for validity by GPS receiver 200 utilizing receiver processing unit 270. In an example, if mixer 230 output doesn't coincide with an expected frequency, such result may indicate a validity problem. In another example, if frequency offset values fall outside an expected range, this result may indicate a validity problem.

In this embodiment, failure of a validity analysis merely indicates invalid data has been received from or produced by the associated component. One or more additional validity analysis from additional components may be required for an interference determination to be reached. Certain specific validity analysis failures, as determined by the service provider 170, may be required to indicate an interference determination, and are referred to as a profile. In an example, receiver processing unit 270 will consider the received signal to be jammed if a combination of the above components indicate a saturated RF Automatic Gain Control (AGC) immediately followed by a loss of code correlation, carrier tracking, and navigation data demodulation in every RF channel.

Once an interference determination has been reached, receiver processing unit 270 stores the interference data for later transmission to service provider 170. In one embodiment, stored interference data includes the location, time, and such other data requirements that the service provider 170 requests, and may be referred to as interference information. In another embodiment, the stored interference data is transmitted to service provider 170 at a specified time interval.

In yet another embodiment, the stored interference data is transmitted when service provider 170 requests the data. In another embodiment, service provider 170 provides one or more additional profiles that would require immediate transmission upon interference data matching the profile(s), and referred to as immediate transmissions.

Exemplary GPS Interference Information Request and Reception

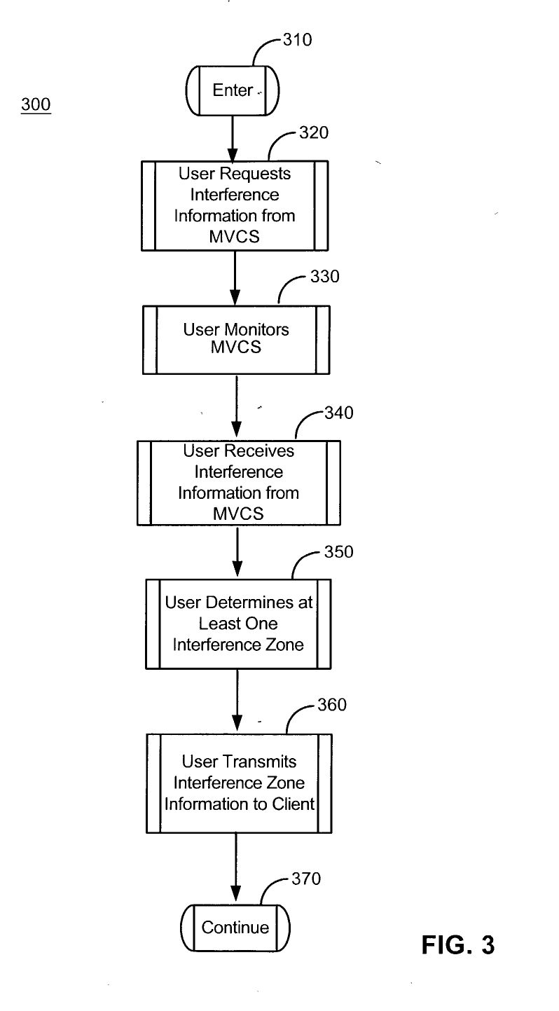

FIG. 3 is a flow diagram depicting an exemplary embodiment of code on a computer readable medium in accordance with the present invention. FIG. 3 details an embodiment of a method 300 for obtaining GPS interference information from a mobile vehicle communication service, in accordance with the present invention. Method 300 may utilize one or more systems detailed in FIGS. 1 and 2 above.

Method 300 begins at block 310 where a user determines a need to obtain GPS interference information from a mobile vehicle communication service (MVCS). In one embodiment, the MVCS is a civilian MVCS. Method 300 allows the user to request interference information from one or more mobile vehicles that include at least one user defined profile for return of the requested information.

In one embodiment, the user is implemented as service provider 170 and described in FIG. 2 above. In another embodiment, the mobile vehicle communication service (MVCS) is implemented as MVCS 100 of FIG. 1. In one example, the MVCS may be implemented as part of an OnStar system, as is known in the art, with regard to wireless communications, and as part of a GPS system, as is known in the art, with regard to satellite GPS and terrestrial digital GPS communications.

In yet another embodiment, the user is implemented as service provider 170 as known in the art and detailed in FIG. 1 above. In another embodiment, the user is implemented as a call center as known in the art. Method 300 then advances to block 320.

At block 320, the user requests interference information from one or more mobile vehicles within the mobile vehicle communication system (MVCS). In one embodiment, mobile vehicles within the MVCS are programmed to transmit requested interference information at a specified time interval. In another embodiment, the user directs one or more vehicles within the MVCS to transmit the requested interference information at a specified time, such as, for example an immediate request. The method then advances to block 330.

At block 330, the user monitors MVCS. In one embodiment, the user monitors the MVCS for regularly scheduled transmissions. In another embodiment, the user monitors the MVCS for user requested transmissions. In yet another embodiment, the user monitors the MVCS for unscheduled immediate transmissions as described in FIG. 2, above. The method then advances to block 340.

At block 340, the user receives interference information from the mobile vehicle communication system (MVCS). In one embodiment, the user receives regularly scheduled interference information from the MVCS. In another embodiment, the user receives user requested interference information from the MVCS. In yet another embodiment, the user receives unscheduled immediate interference information from the MVCS as described in FIG. 2, above. The method then advances to block 350.

At block 350, the user determines one or more interference regions based on the received interference information. In one embodiment, the interference regions are determined by storing and mapping, also referred to as plotting, the received interference information on a geographic representation of the area at regular intervals. Interference regions are then identified based on the mapped interference information.

In an example, the interference regions are plotted using Geographic Information Services (GIS) mapping software such as, ArcView by ESRI of Redlands, Calif., and MapInfo Professional by MapInfo of Troy, N.Y. The method then advances to block 360.

At block 360, the user transmits the one or more interference regions to a client. In one embodiment, the user transmits specific interference regions based on mapping performed in block 350 above.

The client may represent government authorities, industry engineers, transportation officials, and the like. In an example, the client is The United States Department of Transportation. In another example, the client is The Federal Communication Commission. In yet another example, the client is The United States Department of Defense. The method then advances to block 370, where it returns to standard programming.

The present invention seeks to provide accurate wide-area GPS interference information due to extensive road nets in most locales. Additionally, by providing large amounts of data collectors on land, sea, and in the air, it is likely strong interference sources will be detected and reported by multiple vehicles, thus increasing the ability to precisely locate the interference source.

Whenever or wherever mobile vehicles are in use, an onboard GPS receiver is continuously monitoring and tracking the GPS constellation. GPS receivers can be found on virtually all roads, on all the oceans, and in the skies throughout the world, 24 hours per day, 365 days per year. In one embodiment, GPS receivers utilized within the scope of the present invention are embedded within a cellular transceiver that communicates real-time location data to a server.

The mobile vehicle communication system (MVCS) infrastructure provides an ideal platform upon which to base a GPS interference information gathering network. In one example, MVCS 100 is implemented as an OnStar system, as is known in the art, with regards to wireless communications, and as a GPS system, as is known in the art, with regards to satellite and radio GPS communications.

The above-described methods and implementation for providing GPS interference information from a mobile vehicle communication system (MVCS) are example methods and implementations. These methods and implementations illustrate one possible approach for providing GPS interference information from a mobile vehicle communication system (MVCS). The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

We claim:

1. A method for providing global positioning system interference information, the method comprising:
requesting interference information from at least one mobile vehicle within a mobile vehicle communication service, the interference information corresponding to a specified profile;
monitoring the mobile vehicle communication service;
receiving the requested interference information from the at least one mobile vehicle within the mobile vehicle communication service;
determining at least one interference region based on the received interference information; and
transmitting the at least one determined interference region to a client.

2. The method of claim 1 wherein the interference information includes information from a group consisting of: time of interference, mobile vehicle longitude, mobile vehicle latitude, mobile vehicle velocity, and mobile vehicle heading.

3. The method of claim 1 wherein the method of requesting the interference information further comprises utilizing at least one terrestrial digital radio network.

4. The method of claim 1 wherein the method of determining at least one interference region comprises:
storing the interference information within a database;
mapping the interference information to an associated geographic representation; and
identifying at least one interference region based on the mapped interference information.

5. A system for providing global positioning system interference information comprising:
means for requesting interference information from at least one mobile vehicle within a mobile vehicle communication service, the interference information corresponding to a specified profile;
means for monitoring the mobile vehicle communication service;
means for receiving the requested interference information from the at least one mobile vehicle within the mobile vehicle communication service;
means for determining at least one interference region based on the received interference information; and
means for transmitting the at least one determined interference region to a client.

6. The system of claim 5 wherein the interference information includes information from a group consisting of: time of interference, mobile vehicle longitude, mobile vehicle latitude, mobile vehicle velocity, and mobile vehicle heading.

7. The system of claim 5 wherein the means for requesting the interference information further comprises means for utilizing at least one terrestrial digital radio network.

8. The system of claim 5 wherein the means for determining at least one interference region comprises:
means for storing the interference information within a database;
means for mapping the interference information to an associated geographic representation; and
means for identifying at least one interference region based on the mapped interference information.

9. A computer readable medium for providing global positioning system interference information comprising:
computer readable code for requesting interference information from at least one mobile vehicle within a mobile vehicle communication service, the interference information corresponding to a specified profile;
computer readable code for monitoring the mobile vehicle communication service;
computer readable code for receiving the requested interference information from the at least one mobile vehicle within the mobile vehicle communication service;
computer readable code for determining at least one interference region based on the received interference information; and
computer readable code for transmitting the at least one determined interference region to a client.

10. The computer readable medium of claim 9 wherein the interference information includes information from a group consisting of: time of interference, mobile vehicle longitude, mobile vehicle latitude, mobile vehicle velocity, and mobile vehicle heading.

11. The computer readable medium of claim 9 wherein the computer readable code for requesting the interference information further comprises computer readable code for utilizing at least one terrestrial digital radio network.

12. The computer readable medium of claim 9 wherein the computer readable code for determining at least one interference region comprises:
computer readable code for storing the interference information within a database;
computer readable code for mapping the interference information to an associated geographic representation; and
computer readable code for identifying at least one interference region based on the mapped interference information.
